(19) United States
(12) Patent Application Publication
(10) Pub. No.: US 2013/0201573 A1
(43) Pub. Date: Aug. 8, 2013

(54) OPTICAL ELEMENT

(71) Applicant: NTL Technologies, Ltd., Kanagawa (JP)

(72) Inventor: Kunihiro SHIOTA, Kanagawa (JP)

(73) Assignee: NTL Technologies, Ltd., Kanagawa (JP)

(21) Appl. No.: 13/750,685

(22) Filed: Jan. 25, 2013

(30) Foreign Application Priority Data
Feb. 3, 2012 (JP) 2012-021870
Nov. 12, 2012 (JP) 2012-248054

(51) Int. Cl. G02B 5/22

(52) U.S. Cl. CPC G02B 5/22
USPC 359/885

(57) ABSTRACT

To provide an optical element capable of suppressing at least either aggregation of the protruded patterns or generation of dents in the light absorbing layer during manufacturing steps. The micro louver includes: a transparent substrate; a transparent layer formed on a surface of the transparent substrate; provided that the surface of the transparent layer in contact with the transparent substrate of the transparent layer is a bottom face and the opposite side thereof is an upper face, a plurality of protruded patterns formed on the transparent layer by being isolated from each other by having the upper face as the top face; and a light absorbing layer formed between the protruded patterns. Further, regarding the section of the protruded pattern as a face perpendicular to the surface of the transparent substrate, a width on the upper face side of is wider than a width on the bottom face side.

### CROSS-REFERENCE TO RELATED APPLICATION

This application is based upon and claims the benefit of priority from Japanese patent application No. 2012-248054, filed on Nov. 12, 2012 and No. 2012-248054, filed on Nov. 12, 2012, the disclosure of which is incorporated herein in its entirety by reference.

### BACKGROUND OF THE INVENTION

1. Field of the Invention

The present invention relates to an optical element such as a micro louver which restricts the range of exit directions of transmission light.

2. Description of the Related Art

Liquid crystal display devices are used as display devices of various kinds of information processing devices such as mobile phones, PDAs (Personal Digital Assistants), ATMs (Automatic Teller Machines), and personal computers. Recently, liquid crystal display devices with a wide visible range are put into practical use. Further, in accordance with the appearance of the large-sized displays and the multiple use purposes thereof, various light alignment properties are required for the liquid crystal display devices. In particular, a demand for restricting the visible range for not allowing the others to peep in and a demand for not emitting the light in the unnecessary directions have been raised in terms of information leakages. For fulfilling such demands, a micro louver that is an optical film capable of restricting the visible range (or exit range) of the display has been proposed and has been put into practice partially.

The micro louver is formed by alternately arranging a light transmission region and a light shielding region of a high aspect ratio on a substrate in a plan manner to restrict the light exit directions. For example, proposed is a micro louver using a polymer film as a substrate, in which the light transmission region is formed by curing a transparent photosensitive resin through exposure and applying heat. FIG. 18 shows sectional views of micro louvers of related techniques, in which FIG. 18A is a related technique 1 and FIG. 18B is a related technique 2. A micro louver 800 of the related technique 1 includes: a transparent substrate 810; a transparent layer 820 formed on a surface 811 of the transparent substrate 810; a plurality of protruded patterns 830 formed on the transparent layer 820 by being isolated from each other by having an upper face 822 as the top face thereof, provided that the surface of the transparent layer 820 in contact with the transparent substrate 810 of the transparent layer 820 is a bottom face 821 and the opposite side of the bottom face 821 is the upper face 822; and a light absorbing layer 840 formed between the protruded patterns 830. Further, regarding the section of the protruded pattern 830 that is the surface perpendicular to the surface 811 of the transparent substrate 810, a width 832 on the upper face 822 side is narrower than a width 831 on the bottom face 821 side (hereinafter, this sectional shape is referred to as “forward tapered shape”). The micro louver 800 is disclosed in FIG. 3 of Japanese Unexamined Patent Publication 2010-085919 (Patent Document 1), FIG. 2 of Japanese Unexamined Patent Publication 2008-242232 (Patent Document 2), FIG. 3 of Japanese Unexamined Patent Publication 2011-501219 (Patent Document 3), and FIG. 12B of Japanese Unexamined Patent Publication 2007-272161 (Patent Document 4), for example.

A micro louver 900 of the related technique 2 includes: a transparent substrate 910; a transparent layer 920 formed on a surface 911 of the transparent substrate 910; a plurality of protruded patterns 930 formed on the transparent layer 920 by being isolated from each other by having an upper face 922 as the top face thereof, provided that the surface of the transparent layer 920 in contact with the transparent substrate 910 of the transparent layer 920 is a bottom face 921 and the opposite side of the bottom face 921 is the upper face 922; and a light absorbing layer 940 formed between the protruded patterns 930. Further, regarding the section of the protruded pattern 930 that is the surface perpendicular to the surface 911 of the transparent substrate 910, a width 931 on the bottom face 921 side is equivalent to a width 932 on the upper face 922 side (hereinafter, this sectional shape is referred to as “perpendicular shape”). The micro louver 900 is disclosed in FIG. 2 of Japanese Unexamined Patent Publication 2010-139884 (Patent Document 5), for example.

The manufacturing method of the micro lover 900 according to the related technique 2 includes following steps. A step of forming the transparent layer 920 constituted with a photoresist on the surface 911 of the transparent substrate 910. A step of exposing the transparent layer 920 by irradiating light to the transparent layer 920 through a photomask (not shown), provided that the surface of the transparent layer 920 in contact with the transparent substrate 910 is the bottom face 921 and the opposite side of the bottom face 921 is the upper face 922. A step of forming the plurality of protruded patterns 930 isolated from each other by having the upper face 922 as the top face through immersing the exposed transparent layer 920 in a developing solution 953 (FIG. 19A). A step of applying a liquid resin 941 (FIG. 21A) to be the light absorbing layer 940 on the upper face 922 including the spaces between the protruded patterns 930. A step of wiping off the excessive liquid resin 941 (FIG. 21B) from the upper face 922.

Further, FIG. 1 of Japanese Unexamined Patent Publication 2002-267813 (Patent Document 6) discloses a light diffusing film using a great number of ball-type transparent beads.

However, there are following issues with the related techniques 1 and 2.

The first issue is that it becomes impossible to form the light absorbing layer because the protrude patterns are aggregated with each other. FIG. 19 is a sectional view for describing the phenomenon where the protruded patterns are aggregated with each other in the related technique 2. Immediately after the development, the developing solution 953 remains between the protruded patterns 930 (FIG. 19A). The developing solution 953 also functions as a cleaning solution. The remaining developing solution 953 is removed by drying. At that time, the force for drawing the protruded patterns 930 to each other is increased in accordance with decrease of the developing solution 953 (FIG. 19B). This force is considered as a force generated by adding the surface tension that works to minimize the surface area of the developing solution 953 to the intermolecular force of the developing solution 953 that is to be absorbed to the protruded patterns 930. As a result, the protruded patterns 930 are aggregated after being dried (FIG. 19C).

The force for drawing the protruded patterns 930 to each other depends on a space S12 in the region where the developing solution 953 remains, and it becomes greater as the space 12 becomes narrower. Thus, this issue becomes more prominent with the related technique 1 since the protruded pattern 830 is in a forward tapered shape as shown in FIG. 20. That is, a base S11′ of a space S11 becomes still narrower, so that the protruded patterns 830 are aggregated in the base S11′.

Further, due to the recent demands for micronization and minimization of the size, the spaces S11 and S12 are more narrowed year by year, so that this issue is expected to become more serious. The phenomena of aggregation of the protruded patterns 830 with each other and the protruded patterns 930 with each other may occur not only immediately after development but also in other steps due to the intermolecular force generated by narrowing the spaces S11 and S12.

The second issue is that a part of the light absorbing layer is missed out because the liquid resin is not filled sufficiently between each of the protruded patterns. FIG. 21 is a sectional view for describing the phenomenon where the liquid resin cannot be filled sufficiently between each of the protruded patterns in the related technique 2. First, the liquid resin 941 is applied to the upper face 922 including the spaces between each of the protruded patterns 930 (FIG. 21A). Subsequently, the excessive liquid resin 941 is wiped off from the upper face 922 by using a soft sponge such as polyurethane or the like (FIG. 21B). At this time, a part of the sponge 954 enters from the opening parts of the spaces S12 between each of the protruded patterns 931, and removes a part of the liquid resin 941 filled between each of the protruded patterns 930. As a result, the liquid resin 941 cannot be filled sufficiently to the spaces between each of the protruded patterns 931, thereby generating dents 942 in a size that cannot be ignored in the opening parts of the spaces S12 (FIG. 21C). Generation of the dents 942 results in missing out a part of the light absorbing layer 940, which deteriorates the performance of the micro lover 900.

The amount of the liquid resin 941 removed from the spaces between the protruded patterns 930 depends on the opening parts of the spaces S12, and it becomes greater as the size of the opening parts of the spaces S12 becomes larger. Thus, this issue becomes more prominent with the related technique 1 shown in FIG. 20, since it employs the structure in which the size of the opening parts of the spaces S11 between the protruded patterns 830 is large.

It is therefore an exemplary object of the present invention to provide an optical element which can suppress at least either aggregation of the protruded patterns or generation of the dents in the light absorbing layer during the manufacturing steps.

### SUMMARY OF THE INVENTION

The optical element according to an exemplary aspect of the invention includes: a transparent substrate; a transparent layer formed on a surface of the transparent substrate; provided that a face of the transparent layer in contact with the transparent substrate is referred to as a bottom face and an opposite side of the bottom face is referred to as an upper face, a plurality of protruded patterns formed on the transparent layer by being isolated from each other by having an upper face as a top face; and a light absorbing layer formed on spaces between each of the protruded patterns, wherein, regarding a section of the protruded pattern as a face perpendicular to the surface of the transparent substrate, a width on the upper face side is wider than a width on the bottom face side.

### BRIEF DESCRIPTION OF THE DRAWINGS

FIG. 1 is a sectional view showing a micro louver according to a first exemplary embodiment;

FIGS. 2A-2D show first sectional views showing a manufacturing method of the micro louver according to the first exemplary embodiment, in which steps thereof are executed in order of FIG. 2A→FIG. 2B→FIG. 2C→FIG. 2D;

FIGS. 3A-3C show second sectional views showing the manufacturing method of the micro louver according to the first exemplary embodiment, in which steps thereof are executed in order of FIG. 3A→FIG. 3B→FIG. 3C;

FIGS. 4A-4C show sectional views for describing the phenomenon where the protruded patterns are not aggregated with each other in the first exemplary embodiment, in which FIG. 4A shows a state immediately after development, FIG. 4B shows a state where a developing solution is removed, and FIG. 4C shows a state where the protruded patterns are not aggregated with each other;

FIGS. 5A-5C show sectional views for describing the phenomenon where the liquid resin can be filled sufficiently to the spaces between the protruded patterns in the first exemplary embodiment, in which FIG. 5A shows a state where a liquid resin to be a light absorbing layer is applied, FIG. 5B shows a state where the excessive liquid resin is being wiped off, and FIG. 5C shows a state where the liquid resin is filled sufficiently to the spaces between the protruded patterns;

FIGS. 6A-6C show fragmentary perspective views showing layout examples of a transparent layer (protruded patterns) and the light absorbing layer according to the first exemplary embodiment, in which FIG. 6A is a first example, FIG. 6B is a second example, and FIG. 6C is a third example;

FIG. 7 is a sectional view showing a micro louver according to a second exemplary embodiment;

FIGS. 8A and 8B show sectional views for describing the effects acquired by the micro louver of the second exemplary embodiment, in which FIG. 8A shows a case without a cover layer and FIG. 8B is a case with a cover layer;

FIG. 9 is a sectional view showing a micro louver according to a third exemplary embodiment;

FIG. 10 is a sectional view showing a micro louver according to a fourth exemplary embodiment;

FIGS. 11A-11D show sectional views showing a manufacturing method of a micro louver according to a fifth exemplary embodiment, in which steps thereof are executed in order of FIG. 11A→FIG. 11B→FIG. 11C→FIG. 11D;

FIG. 12 is a sectional view showing a micro louver according to a sixth exemplary embodiment;

FIGS. 13A-13C show first sectional views showing a manufacturing method of the micro louver according to the sixth exemplary embodiment, in which steps thereof are executed in order of FIG. 13A→FIG. 13B→FIG. 13C;

FIGS. 14A and 14B show second sectional views showing the manufacturing method of the micro louver according to the sixth exemplary embodiment, in which steps thereof are executed in order of FIG. 14A→FIG. 14B;

FIG. 15 is a sectional view showing a micro louver according to a seventh exemplary embodiment;

FIG. 16 is a graph showing the spectral absorption ratio of the protruded patterns;

FIG. 17 is a sectional view showing a micro louver according to an eighth exemplary embodiment;

FIGS. 18A and 18B show sectional views of micro louvers according to related techniques, in which FIG. 18A shows the related technique 1 and FIG. 18B shows the related technique 2;

FIGS. 19A-19C show sectional views for describing the phenomenon where the protruded patterns are aggregated with each other in the related technique 2, in which FIG. 19A shows a state immediately after development, FIG. 19B shows a state where a developing solution is removed, and FIG. 19C shows a state where the protruded patterns are aggregated with each other;

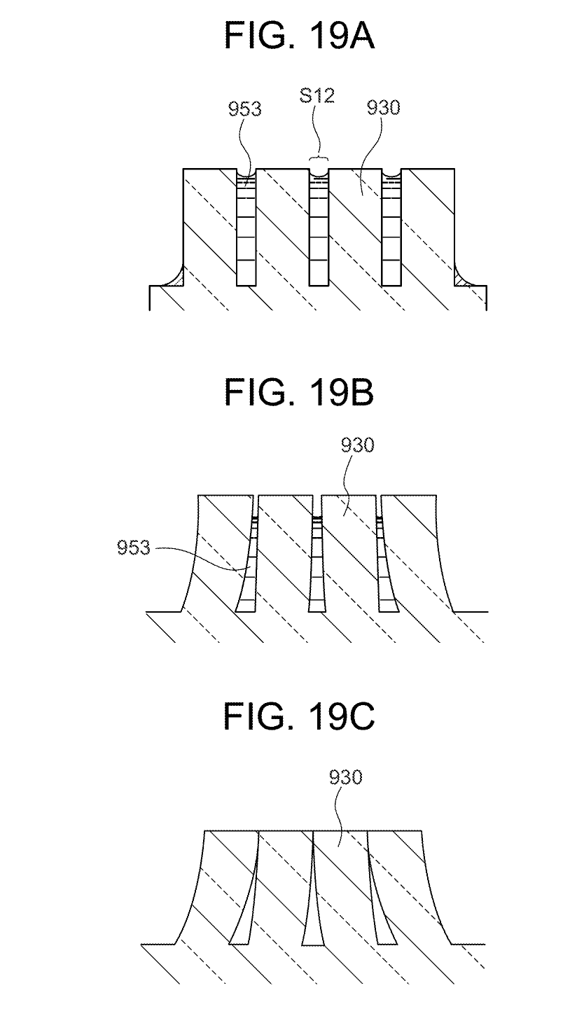

FIG. 20 is a sectional view for describing the phenomenon where the protruded patterns are aggregated with each other in the related technique 1; and

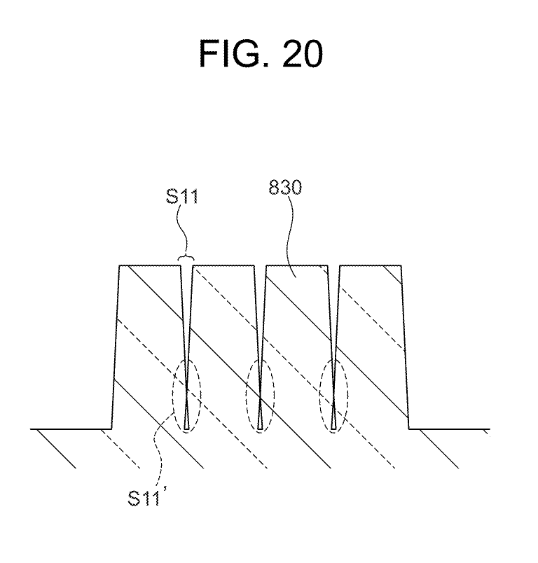

FIGS. 21A-21C show sectional views for describing the phenomenon where the liquid resin cannot be filled sufficiently to the spaces between the protruded patterns in the related technique 2, in which FIG. 21A shows a state where a liquid resin to be a light absorbing layer is applied, FIG. 21B shows a state where the excessive liquid resin is being wiped off, and FIG. 21C shows a state where the liquid resin cannot be filled sufficiently to the spaces between the protruded patterns.

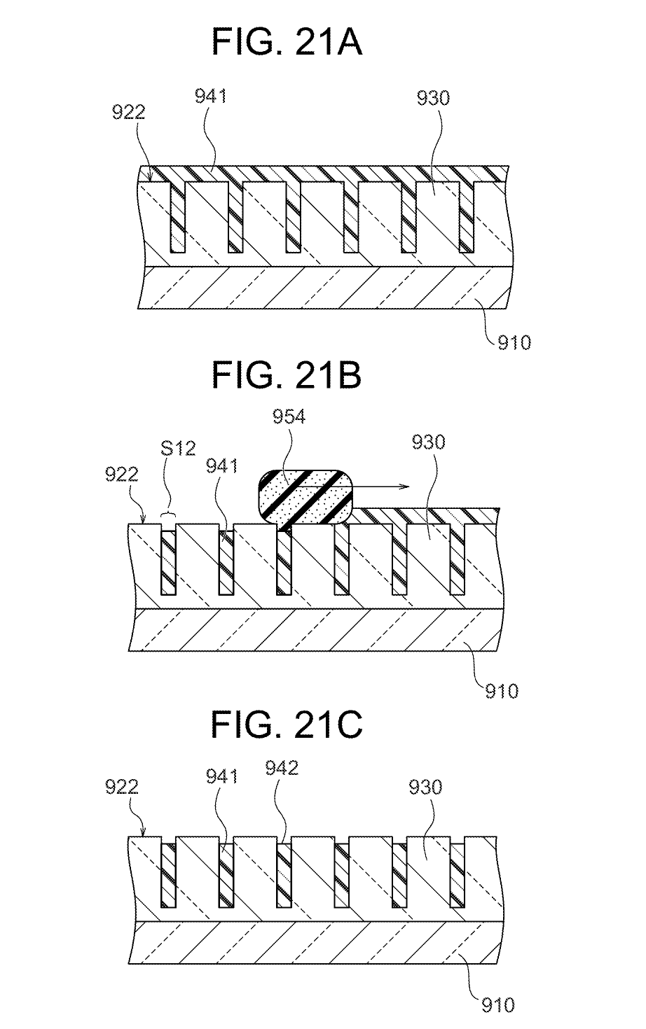

### DETAILED DESCRIPTION OF THE PREFERRED EMBODIMENTS

Hereinafter, modes (referred to as exemplary embodiments hereinafter) for embodying the present invention will be described by referring to the accompanying drawings. Note that same reference numerals are used for substantially same structural elements in this Specification and the drawings. Shapes illustrated in the drawings are written in a manner to be easily understood by those skilled in the art, so that sizes and ratios thereof are not necessarily consistent with the actual ones. In each of the following exemplary embodiments, a micro louver is employed for explanations as an example of the optical element according to the present invention.

### First Exemplary Embodiment

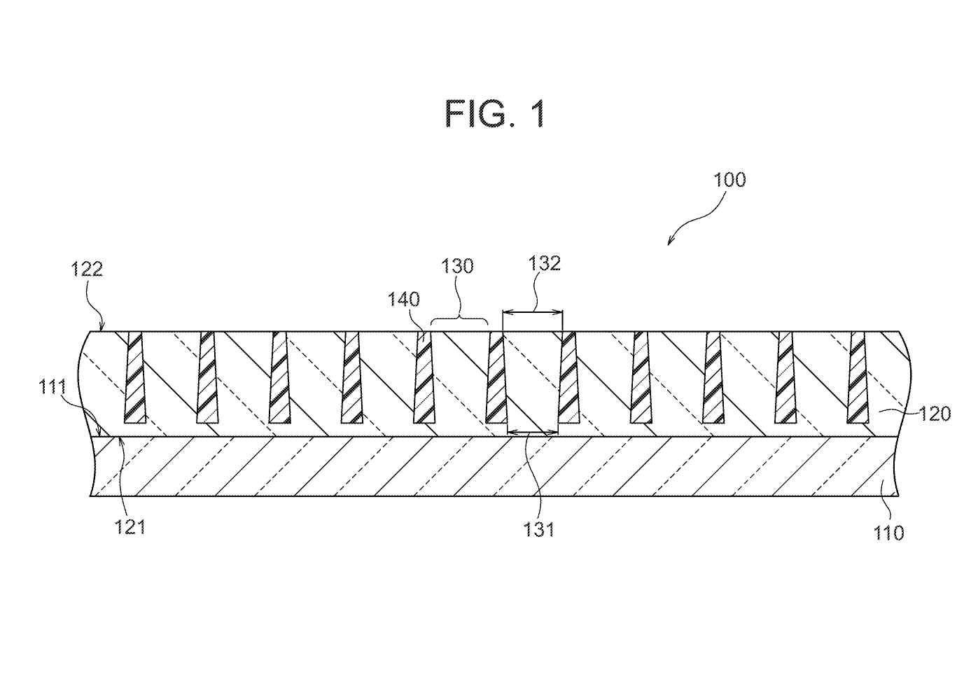

FIG. 1 is a sectional view showing the micro louver of the first exemplary embodiment. Hereinafter, the outline of the micro louver according to the first exemplary embodiment will be described by referring to this drawing.

The micro louver 100 of the first exemplary embodiment includes: a transparent substrate 110; a transparent layer 120 formed on a surface 111 of the transparent substrate 110; a plurality of protruded patterns 130 formed in the transparent layer 120 by being isolated from each other by having an upper face 122 as the top face thereof, provided that the face of the transparent layer 120 in contact with the transparent substrate 110 is a bottom face 121 and the opposite side of the bottom face 121 is the upper face 122; and a light absorbing layer 140 formed between the protruded patterns 130. Further, regarding the section of the protruded pattern 130 as the surface perpendicular to the surface 111 of the transparent substrate 110, a width 132 on the upper face 122 side is wider than a width 131 on the bottom face 121 side (hereinafter, this sectional shape is referred to as “reverse tapered shape”).

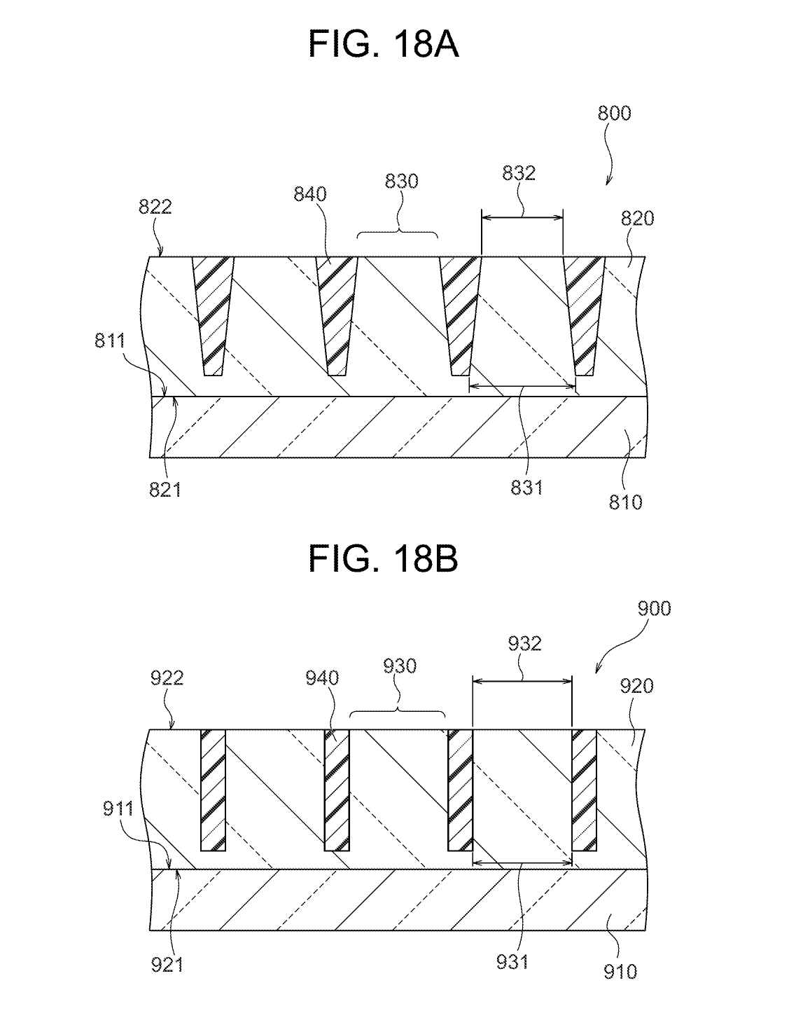

The section of the protruded pattern 130 of the first exemplary embodiment is a reverse tapered shape, while the section of the protruded pattern 830 of the related technique 1 shown in FIG. 18A is a forward tapered shape and the section of the protruded pattern 930 of the related technique 2 shown in FIG. 18B is a perpendicular shape.

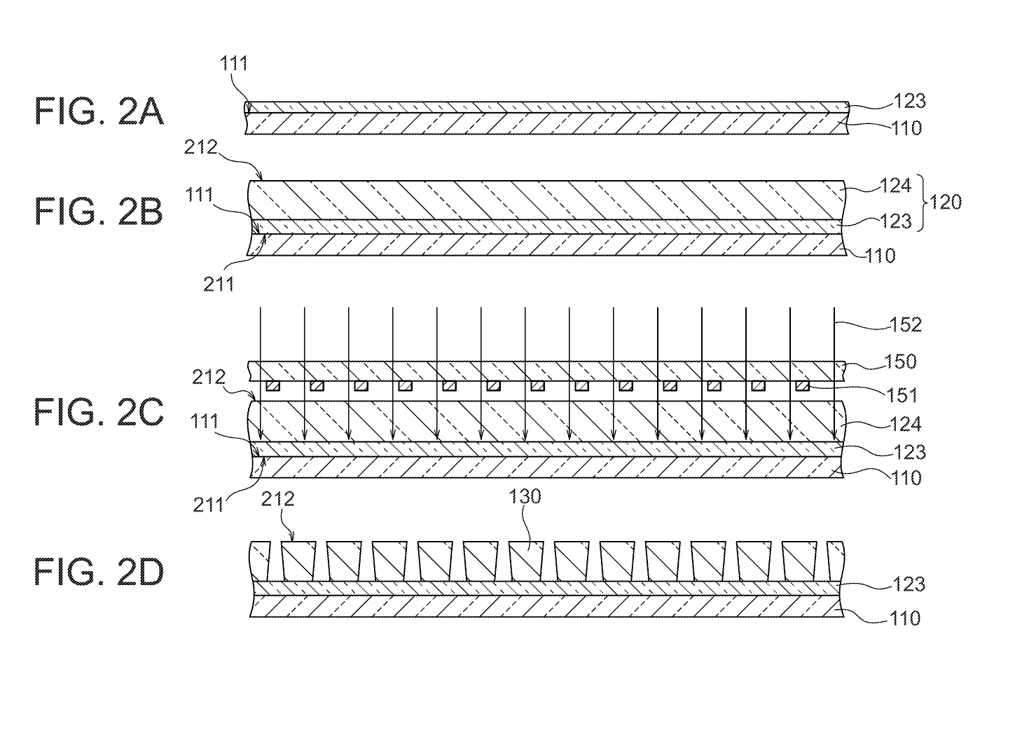

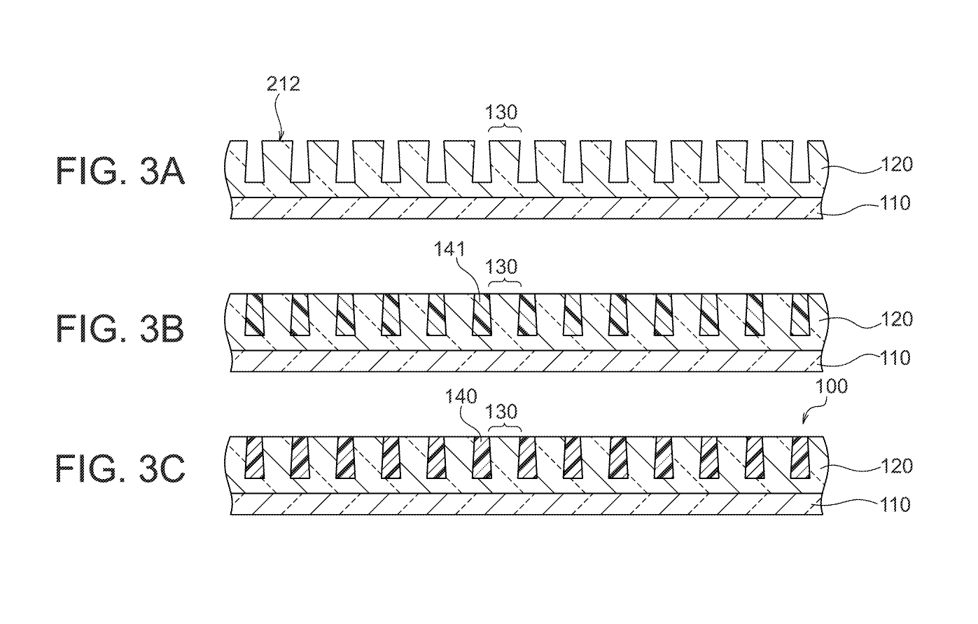

FIGS. 2A-2D and FIGS. 3A-3C are sectional views showing the manufacturing method of the micro louver according to the first exemplary embodiment. The outline of an example of the method for manufacturing the micro louver of the first exemplary embodiment will be described by referring to those drawings.

The manufacturing method of the micro louver according to the first embodiment includes following steps.

A step of forming a base layer 123 and a transparent photosensitive resin layer 124 as a negative-type photoresist film to be the transparent layer 120 on the surface 111 of the transparent substrate 110 (FIGS. 2A, 2B). Note here that it is so defined here that the face of the photoresist film constituted with the base layer 123 and the transparent photosensitive resin layer 124 in contact with the transparent substrate 110 is the bottom face 121 and the opposite side of the bottom face 121 is the upper face 122.

A step of exposing the transparent photosensitive resin layer 124 by irradiating light 152 to the transparent photosensitive resin layer 124 through a photomask 150 (FIG. 2C).

A step of forming the plurality of protruded patterns 130 isolated from each other by having the upper face 122 as the top face through immersing the exposed transparent photosensitive resin layer 124 in a developing solution 153 (FIG. 2D, FIG. 3A).

A step of applying a black curing resin 141 as a liquid resin to be the light absorbing layer 140 on the upper face 122 including the spaces between the protruded patterns 130, and wiping off the excessive black curing resin 141 from the upper face 122 (FIG. 3B).

Further, in the step of exposing the transparent photosensitive resin layer 124 (FIG. 2C), the exposure amount is so adjusted that the section of the protruded pattern 130 as the face perpendicular to the surface 111 of the transparent substrate 110 becomes a reverse tapered shape. At this time, the transparent photosensitive resin layer 124 is a negative type (exposed part remains), and the light 152 is irradiated to the transparent photosensitive resin layer 124 from the upper face 122 side through the photomask 150. The exposure amount at this time is set to be smaller than the case of forming the section of the protruded pattern 130 into a perpendicular shape, for example. The reason thereof is as follows.

The intensity of the light 152 to be a single spot beam transmitted through the photomask 150 becomes lower in the fringe thereof due to diffraction. In the meantime, regarding the transparent photosensitive resin layer 124, the intensity of the light 152 becomes lower as it becomes farther from the photomask 150 since the light 152 is absorbed from the region closer to the photomask 150. Thus, when the exposure amount is set smaller, a nonsensitized part is formed more in the region of the transparent photosensitive resin layer 124 farther from the photomask 150 and with the light 152 closer to the fringe thereof. In the case of forming the section of the protruded pattern 130 to a perpendicular shape, the exposure amount is set to be great so that the part that is hard to be photosensitized can be sufficiently photosensitized. Therefore, through reducing the exposure amount than the case of forming the section of the protruded pattern 130 to a perpendicular shape, the section of the protruded pattern 130 can be formed in a reverse tapered shape.

Next, the effects of the first exemplary embodiment will be described.

The first effect of the first exemplary embodiment is that aggregation of the protruded patterns 130 can be suppressed compared to the cases of the related techniques 1 and 2, since the width 132 on the upper face 122 side is formed wider than the width 131 on the bottom face 121 side in the section of the protruded patterns 130.

The first reason thereof is considered that the protruded pattern 130 is easily moved by an external force since the gravity of the protruded pattern 130 comes to be on the upper face 122 side because the width 132 on the upper face 122 side of the protruded pattern 130 is formed wider. Therefore, even if the protruded patterns 130 are aggregated, the protruded patterns 130 can be easily separated through applying oscillation to those.

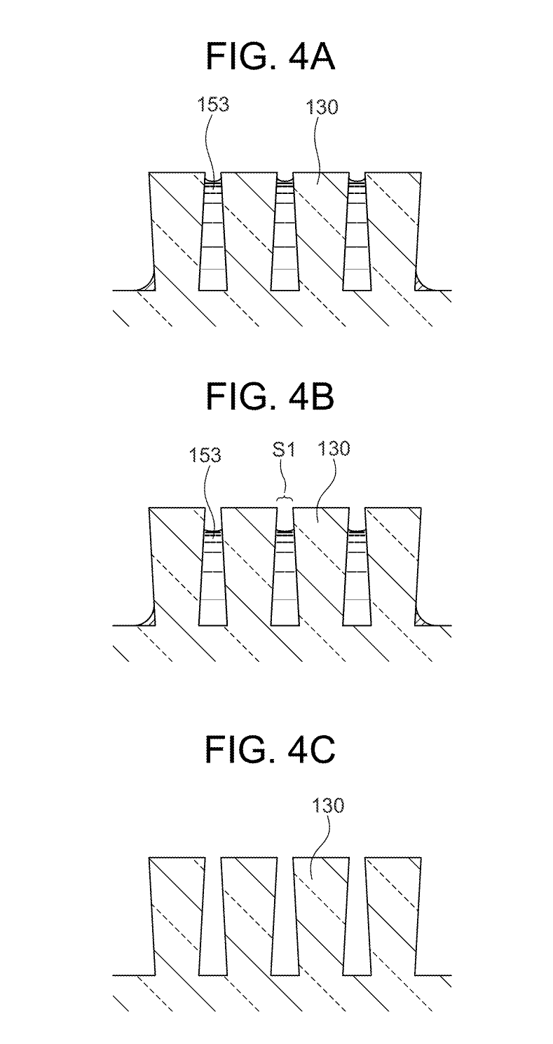

The second reason will be described by referring to FIG. 4. FIG. 4 shows sectional views for describing the phenomenon where the protruded patterns are not aggregated with each other in the first exemplary embodiment. Immediately after development, the developing solution 153 is remained between each of the protruded patterns 130 (FIG. 4A). The developing solution 153 also functions as a cleaning solution. The remaining developing solution 153 is removed by drying. At that time, even when the developing solution 153 is decreased, the force for drawing the protruded patterns 130 to each other is not increased (FIG. 4B). As a result, aggregation of the protruded patterns 130 after drying can be suppressed (FIG. 4C).

As described above, the force for drawing the protruded patterns 130 to each other depends on a space S1 in the region where the developing solution 153 is remained, and it becomes greater as the space S1 becomes narrower. However, the section of the protruded pattern 130 is in a reverse tapered shape, the space S1 in the region where the developing solution 153 remains becomes wider in accordance with the decrease of the developing solution 153 (FIG. 4B). This is because the developing solution 153 remains in the wide-width base of the protruded pattern 130 by being pushed by the atmospheric pressure and the gravity. Therefore, the force for drawing the protruded patterns 130 to each other is not increased even when the developing solution 153 is decreased.

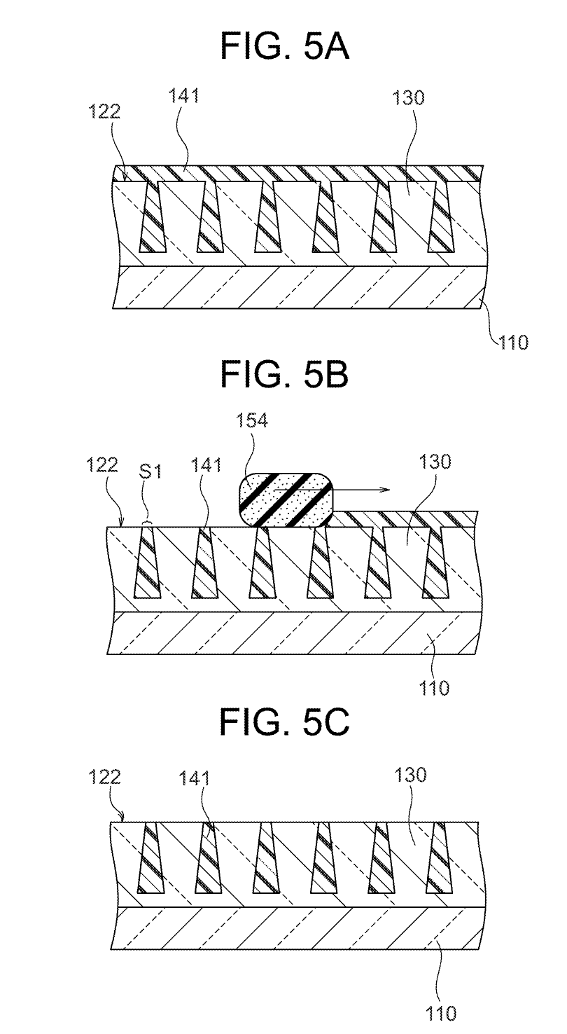

The second effect of this exemplary embodiment is that the black curing resin 141 as the liquid resin can be sufficiently filled to the spaces between each of the protruded patterns 130. FIG. 5 shows sectional views for describing the phenomenon where the black curing resin 141 can be filled sufficiently to the spaces between the protruded patterns 130 in the first exemplary embodiment. First, the black curing resin 141 as the liquid resin is applied to the upper face 122 including the spaces between the protruded patterns 130 (FIG. 5A). Subsequently, the excessive black curing resin 141 is wiped off from the upper face 122 by using the soft sponge 154 such as polyurethane or the like (FIG. 5B). At this time, the sponge 154 entering into the opening part thereof can be ignored practically, since the opening part of the space 51 between each of the protruded patterns 130 is so small. As a result, the black curing resin 141 can be filled sufficiently to the spaces between each of the protruded patterns 130 (FIG. 5C).

As described above, it is possible with the first exemplary embodiment to suppress at least either aggregation of the protruded patterns 130 or generation of the dents in the light absorbing layer 140 in the manufacturing steps through forming the section of the protruded pattern 130 to a reverse tapered shape.

Next, the micro louver 100 will be described in a more detailed manner.

FIG. 1 shows a sectional view of the micro louver 100 in the thickness direction. The micro louver 100 includes the transparent substrate 110. The transparent substrate 110 is made with PET (Poly Ethylene terephthalate) or PC (Poly Carbonate). The transparent layer 120 is formed on the transparent substrate 110. The transparent layer 120 has a shape which includes the protruded patterns 130 on a flat part thereof. Each of the protruded patterns 130 of the transparent layer 120 has such sectional shape in which the top side is wide and the bottom side is narrow, i.e., a reverse tapered shape. The light absorbing layer 140 is formed in the spaces between the protruded patterns 130 of the transparent layer 120. The height of the protruded pattern 130 is appropriate to fall within the range of 30 μm to 300 μm, and it is set as 60 μm in the first exemplary embodiment. The width of the protruded pattern 130 is appropriate to fall within the range of 5 μm to 150 μm. In the first exemplary embodiment, it is set as 20 μm on the surface side (i.e., the width 132) and set as 18 μm on the transparent substrate 110 side (i.e., the width 131). Further, the width of the light absorbing layer 140 is appropriate to fall within the range of 1 μm to 30 μm. In the first exemplary embodiment, it is set as 5 μm on the surface side and set as 7 μm on the transparent substrate 110 side. As described, the transparent layer 120 includes the reverse tapered protruded patterns 130. Therefore, the tip end of the protruded pattern 130 is wider than the transparent substrate 110 side by about 2 μm, and the tip end of the light absorbing layer 140 is narrowed because the tip end of the protruded pattern 130 is formed wider. Furthermore, the refractive index of the light absorbing layer 140 is set to be equivalent to or higher than that of the transparent layer 120 in order to prevent light reflection at the interface between the transparent layer 120 and the light absorbing layer 140. The micro louver 100 is designed to be used by having light made incident on the transparent substrate 110.

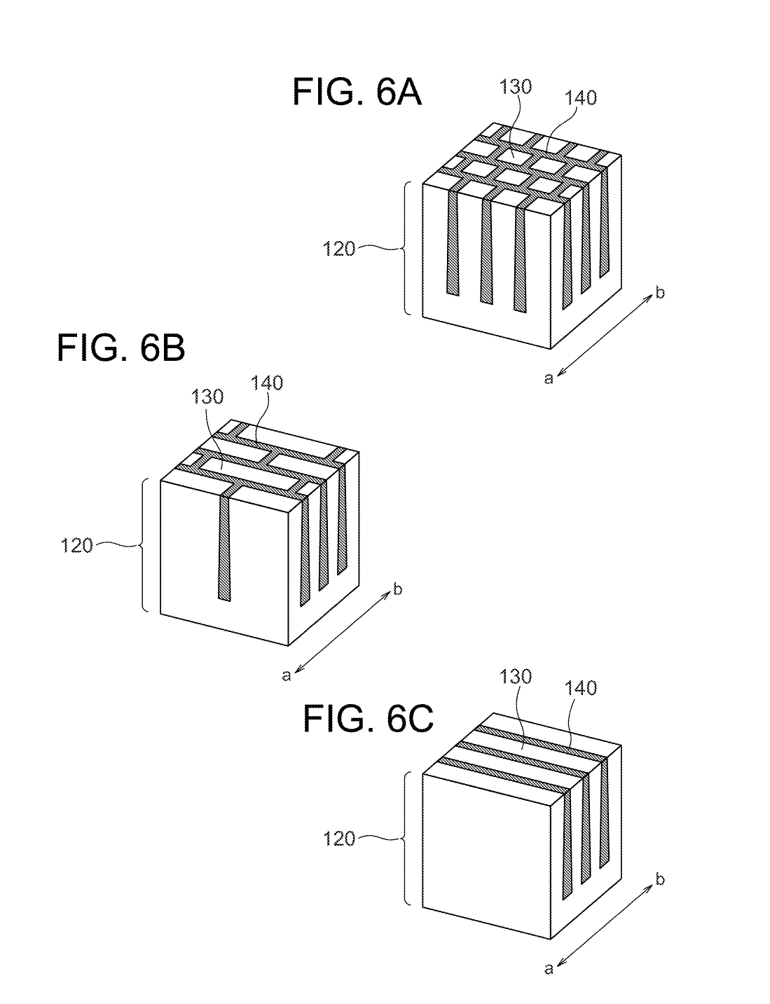

FIGS. 6A-6C show fragmentary perspective views showing layout examples of the transparent layer (protruded patterns 130) and the light absorbing layer according to the first exemplary embodiment, in which FIG. 6A is a first example, FIG. 6B is a second example, and FIG. 6C is a third example. Hereinafter, explanations will be provided by referring to those drawings.

As the layout examples of the transparent layer 120 (the protruded patterns 130) and the light absorbing layer 140, three examples are shown in FIGS. 6A-6C. The first example shown in FIG. 6A is a case where the plane is in a grating form with squares, the second example shown in FIG. 6B is a case where the plane is in a grating form with rectangles, and the third example shown in FIG. 6C is a case where the plane is in a striped shape. The visible angles in the a-b direction shown in each of the drawings of FIGS. 6A-6C are limited to be about ±30 degrees. FIGS. 2A-2D and FIGS. 3A-3C are sectional views showing the manufacturing steps of the micro louver according to the first exemplary embodiment. Hereinafter, the manufacturing steps of the micro louver will be described in a more detailed manner by referring to those drawings.

First, the base layer 123 is formed on the surface 111 of the transparent substrate 110 made with PET or PC (FIG. 2A), and the transparent photosensitive resin layer 124 is formed thereon (FIG. 2B). For the base layer 123, a negative-type transparent photosensitive resin same as the transparent photosensitive resin layer 124 is used. That is, after applying the transparent photosensitive resin on the transparent substrate 110, the whole surface is cured by exposure using UV (Ultra Violet) and applying heat to form the base layer 123. The film thickness of the base layer 123 is appropriate to fall within the range of 5 μm to 30 μm, and it is set as 10 μm in the first exemplary embodiment.

As a method for forming the transparent photosensitive resin layer 124, it is possible to employ any methods using a split die coater, a wire coater, an applicator, dry film transcription, spraying, screen printing, and the like. The thickness of the transparent photosensitive resin layer 124 is appropriate to fall within the range of 30 μm to 300 μm, and it is set as 60 μm in the first exemplary embodiment. The transparent photosensitive resin used for the base layer 123 and the transparent photosensitive resin layer 124 is chemically amplified photoresist (product name “SU-8”) of MicroChem.

The characteristics of the transparent photosensitive resin are as follows. 1. It is an epoxy-based (specifically glycidyl ether derivative of bisphenol A novolac) negative resist with which light indicator generates acid by irradiating ultraviolet rays, and a curing monomer is polymerized by having the proton acid as a catalyst. 2. It exhibits extremely high transparency in visible light regions. 3. The curing monomer contained in the transparent photosensitive resin has relatively small amount of molecules before being cured, so that it is easy to form a thick film since it can be dissolved readily in a solvent of cyclopentanone, propylene glycol methyl ether acetate (PEGMEA), gamma butyl lactone (GBL), isobutyl ketone (MIBK) or the like. 4. It has a characteristic of transmitting the ultraviolet rays even with a thick film, since the light transmittance is extremely fine even with the wavelength of the near-ultraviolet region.

5. Because it exhibits such characteristics, it is possible to form a pattern with an aspect ratio as high as 3 or more. 6. Since there are many functional groups in the curing monomer, it becomes an extremely high-density cross-linkage after being cured, which is extremely stable thermally and chemically. 7. Therefore, processing after forming the pattern becomes easy. Needless to say, the base layer 123 and the transparent photosensitive resin layer 124 are not limited to only the transparent photosensitive resin (product name “SU-8”) mentioned above. Any photocuring materials having the similar characteristics can be used.

Subsequently, the transparent photosensitive resin layer 124 is patterned by using the mask pattern 151 of the photomask 150 (FIG. 2C). The light 152 used for this exposure is parallel light. A UV light source is used as the light source, and UV light with the wavelength of 365 nm is irradiated as the light 152. The exposure amount at this time is appropriate to fall within the range of 50 mJ/cm² to 500 mJ/cm², and it is set as 300 mJ/cm² in the first exemplary embodiment.

By developing it after exposure, the protruded patterns 130 are formed in the transparent photosensitive resin layer 124 (FIG. 2D). The section of the protruded pattern 130 is in a reverse tapered shape which becomes wider towards the surface side from the substrate side. The width of the space between each of the protruded patterns 130 on the surface side is 5 μm, and the width on the base layer 123 side is 9 μm. By forming the protruded patterns 130 in a reverse tapered shape, aggregation of the protruded patterns 130 and the like do not occur at the time of drying and heat annealing after the development even when the space width on the surface side between each of the protruded patterns 130 is as narrow as 5 μm (FIG. 4).

Subsequently, heat annealing is performed under a condition at 120° C. for 30 minutes. The base layer 123 and the protruded patterns 130 are joined in the interface through the heat annealing, thereby forming the transparent layer 120 (FIG. 3A). Further, the refractive index of the transparent layer 120 formed with SU-8 is 1.5.

At last, the black curing resin 141 is filled to the spaces between each of the protruded patterns 130 (FIG. 3B), and the black curing resin 141 is cured to form the light absorbing layer 140 (FIG. 3C). As the black curing resin 141, used is a mixture of 4,4-isopropylidene diphenol-1-chloro-2,3-epoxy propane polycondensation and a black component. As the black component, a pigment, a dye, or a mixture of a pigment and a dye is used. The mixing ratio of the black component is set as 5 wt % to 30 wt %. In the first exemplary embodiment, carbon black is used as the black component, and the mixing ratio thereof is set as 10 wt %. The refractive index of the black curing resin 141 in this case is 1.55, which is slightly higher than the case of forming the transparent layer 120 with SU-8. At this time, the black curing resin 141 is applied on the surface of the transparent layer 120 and the excessive black curing resin 141 on the transparent layer 120 is wiped off by a urethane-made sponge 154 (FIG. 5B) to fill the black curing resin 141 to the spaces between each of the protruded patterns 141.

When a solvent such as acetone, ethanol, isopropyl alcohol, or the like is impregnated to the sponge 154 (FIG. 5B), the black curing resin 141 on each of the protruded patterns 130 can be wiped off completely. As a method for curing the black curing resin 141, heat annealing or UV irradiation is used in general. In the first exemplary embodiment, heat annealing is performed under a condition at 80° C. for 60 minutes. The width of the light absorbing layer 140 on the side closer to the transparent substrate 110 becomes wider since the protruded patterns 130 are formed narrower.

As an exemplary advantage according to the invention, the present invention is designed to employ the shape in which the width on the upper face side in the section of the protruded pattern is formed wider than the width on the bottom face side, thereby making it possible to suppress at least either aggregation of the protruded patterns or generation of the dents in the light absorbing layer during the manufacturing steps.

### Second Exemplary Embodiment

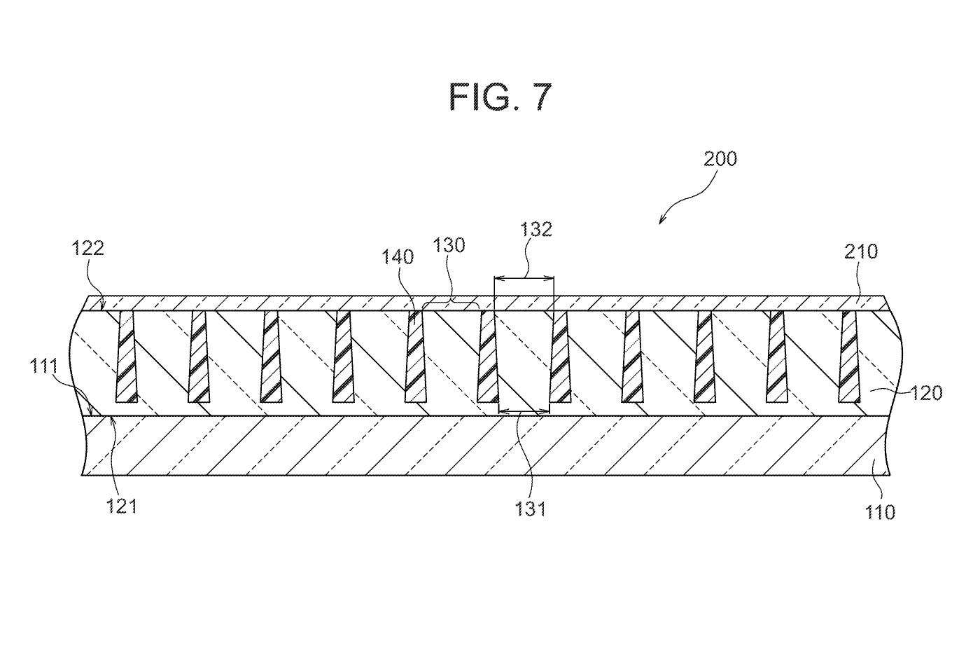

FIG. 7 is a sectional view showing a micro louver according to a second exemplary embodiment.

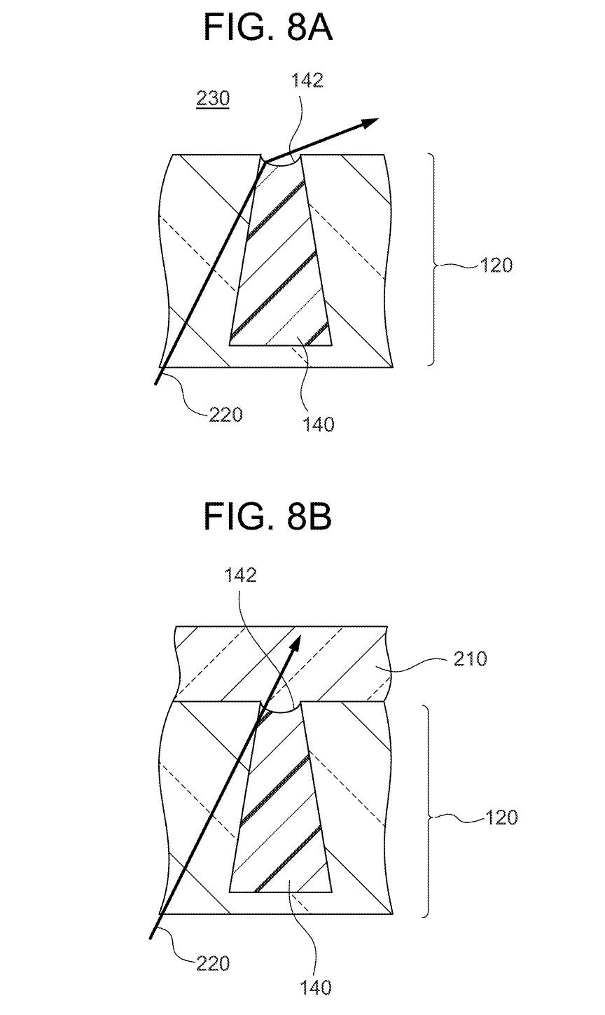

FIG. 8 shows sectional views for describing the effects acquired by the micro louver of the second exemplary embodiment. Hereinafter, explanations will be provided by referring to the drawings. In FIG. 7 and FIG. 8, same reference numerals as those of FIG. 1 are applied to the same components as those of FIG. 1.

FIG. 7 shows a sectional view of the micro louver 200 of the second exemplary embodiment in the thickness direction. In the second exemplary embodiment, a cover layer 210 is disposed on the transparent layer 120 and the light absorbing layer 140 formed on the transparent substrate 110 as in the case of the first exemplary embodiment. The film thickness of the cover layer 210 is appropriate to fall within the range of 5 μm to 50 μm, and it is set as 20 μm in the second exemplary embodiment.

The cover layer 210 is formed directly on the surface of the transparent layer 120 and the light absorbing layer 140 by using a transparent resin (specifically a bisphenol A epoxy resin) that is the basic material of the black curing resin 141 (FIG. 3B). As a method for forming the cover layer 210, a transparent resin layer is deposited by employing any methods using a split die coater, a wire coater, an applicator, dry film transcription, spraying, screen printing, and the like, and the transparent resin layer is then cured by heat annealing. The condition of the heat annealing in the second exemplary embodiment is at 80° C. for 60 minutes.

There may be cases of generating small dents 142 on the upper face of the light absorbing layer 140, although the dents are in a smaller number compared to the cases of the related techniques 1 and 2. Thus, as shown in FIG. 8A, light 220 transmitting through the micro louver 200 when there is no cover layer 210 is refracted at the interface between the dent 142 and air 230, so that it is greatly shifted from the normal direction of the micro louver 200. Therefore, in the second exemplary embodiment, as shown in FIG. 8B, the cover layer 210 having the same refractive index as that of the light absorbing layer 140 is filled into the dent 142. This makes it possible to suppress refraction of the light 220 in the dent 142, so that light leakages can be decreased. Further, the refractive index of the cover layer 210 is preferable to be equivalent or larger than the refractive index of the light absorbing layer 140. It is because the light 220 is refracted towards the normal side of the micro louver 200 as the refractive index of the cover layer 210 becomes greater in that case. Further, the light absorbing layer 140 is a mixture of the resin constituting the cover layer 210 and a light shielding component. The light shielding component is constituted with a pigment such as a dye or carbon black.

Other structures, operations, and effects of the second exemplary embodiment are the same as those described in the first exemplary embodiment.

### Third Exemplary Embodiment

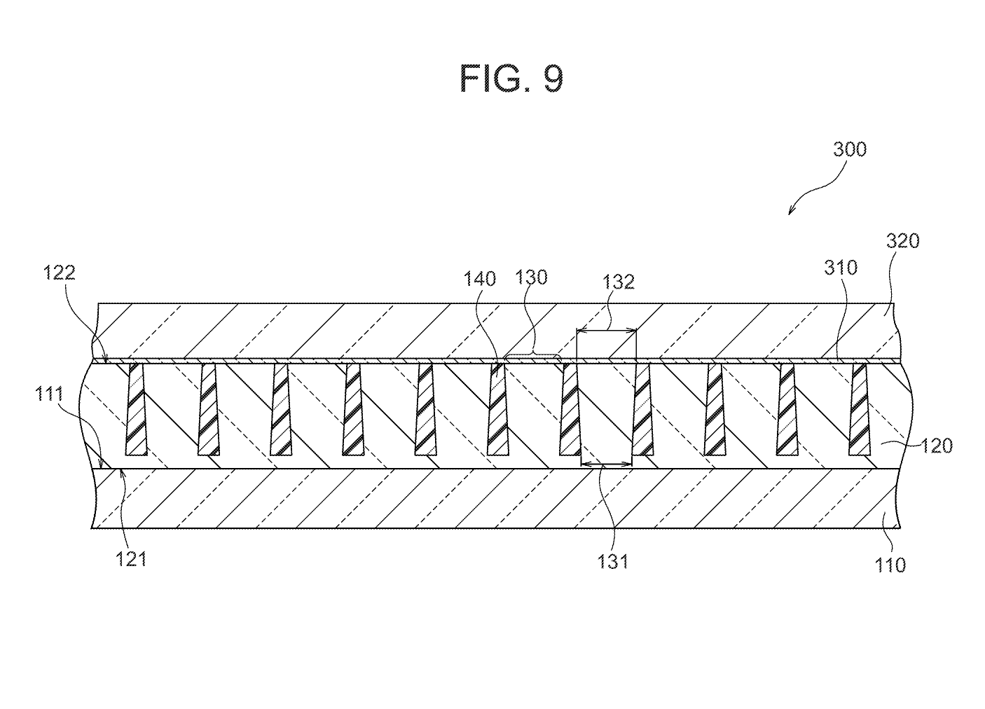

FIG. 9 is a sectional view showing a micro louver according to a third exemplary embodiment. Hereinafter, explanations will be provided by referring to the drawing. In FIG. 9, same reference numerals as those of FIG. 1 are applied to the same components as those of FIG. 1.

FIG. 9 shows a sectional view of the micro louver 300 of the third exemplary embodiment in the thickness direction. In the third exemplary embodiment, a transparent substrate 320 is attached on the transparent layer 120 and the light absorbing layer 140 formed on the transparent substrate 110 as in the case of the first exemplary embodiment via an adhesive layer 310. The film thickness of the adhesive layer 310 is appropriate to fall within the range of 5 μm to 50 μm, and it is set as 10 μm in the third exemplary embodiment. The refractive index of the adhesive layer 310 is set as equivalent to that of the transparent layer 120, and the adhesive layer 310 is formed directly on the surface of the transparent layer 120 and the light absorbing layer 140. In the third exemplary embodiment, an acryl-based adhesive agent having the refractive index of 1.5 is used as the adhesive layer 310. With this, the strength of the surface of the transparent layer 120 and the light absorbing layer 140 is improved, so that the rate of having faults generated due to scars and the like can be decreased. At the same time, deterioration in the transmittance caused because the light is reflected at the interface between the transparent layer 120 and the adhesive layer 310 can be prevented.

Other structures, operations, and effects of the third exemplary embodiment are the same as those described in the first exemplary embodiment.

### Fourth Exemplary Embodiment

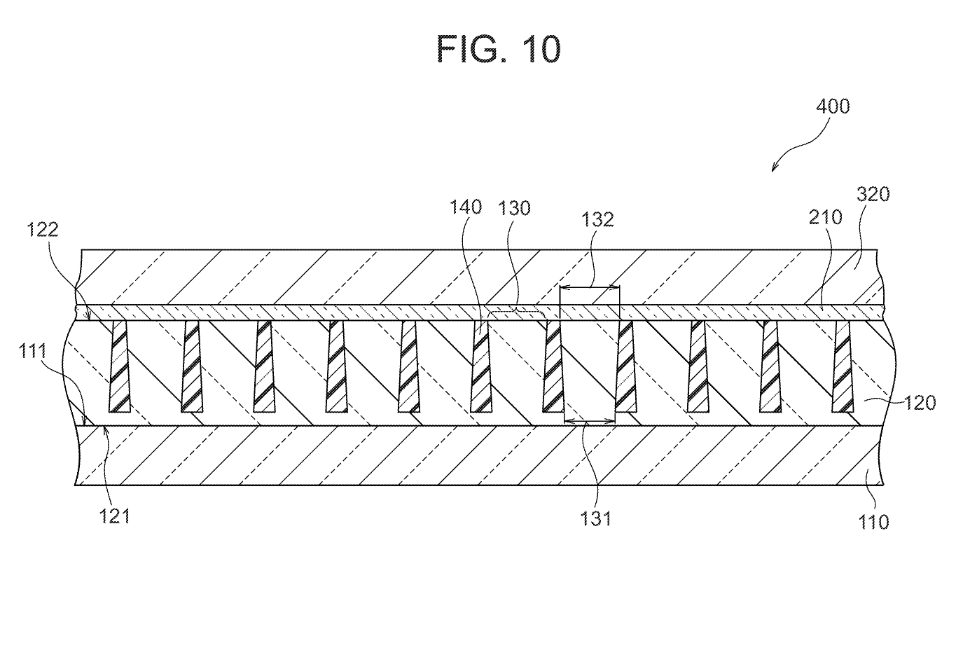

FIG. 10 is a sectional view showing a micro louver according to a fourth exemplary embodiment. Hereinafter, explanations will be provided by referring to the drawings. In FIG. 10, same reference numerals as those of FIG. 1 are applied to the same components as those of FIG. 1, FIG. 7, and FIG. 9.

FIG. 10 shows a sectional view of the micro louver 400 of the fourth exemplary embodiment in the thickness direction. In the fourth exemplary embodiment, the cover layer 210 is applied and formed in the same manner as the case of the second exemplary embodiment on the transparent layer 120 and the light absorbing layer 140 formed on the transparent substrate 110 as in the case of the first exemplary embodiment. Subsequently, a transparent substrate 320 is superimposed on the formed cover layer 210. At this time, it is necessary to pay attention not to have air bubbles entered into the interface between the cover layer 210 and the transparent substrate 320. At last, the cover layer 210 is cured by heat annealing. By heat-annealing the cover layer 210 in a state where the transparent substrate 320 is being superimposed, the transparent substrate 320 is fixed with the cover layer 210. Thus, an adhesive layer becomes unnecessary, so that the cost can be reduced.

Other structures, operations, and effects of the fourth exemplary embodiment are the same as those described in the first exemplary embodiment.

### Fifth Exemplary Embodiment

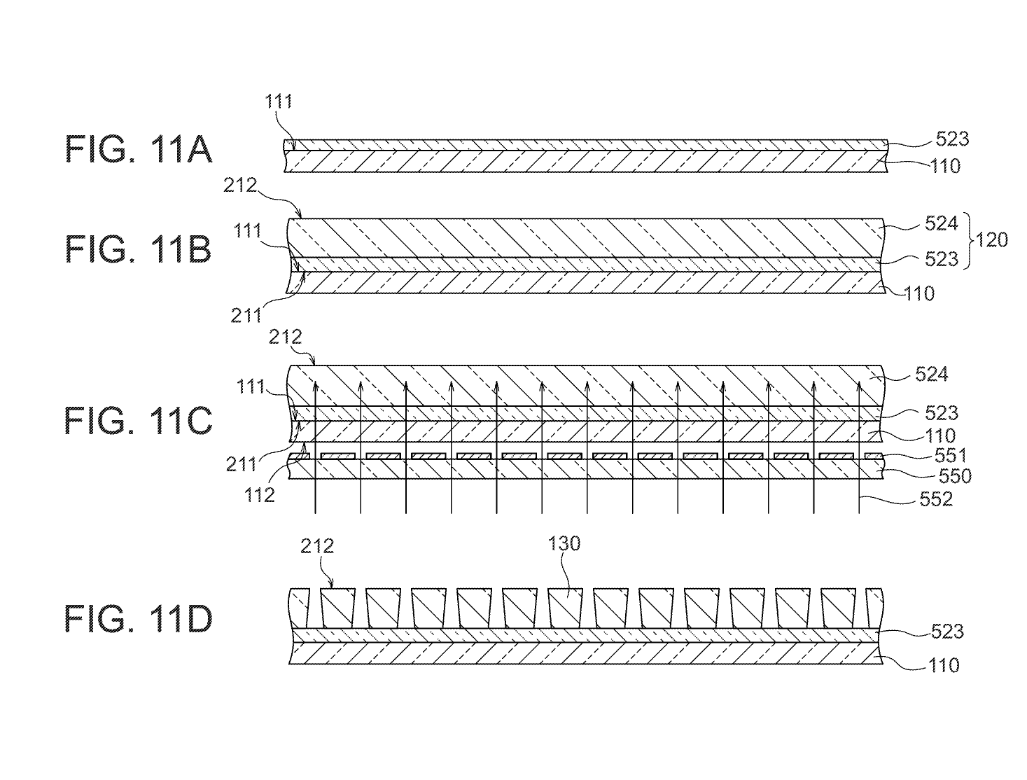

FIG. 11 is a sectional view showing a micro louver manufacturing method according to a fifth exemplary embodiment. Hereinafter, explanations will be provided by referring to the drawing. In FIG. 11, same reference numerals as those of FIG. 2 are applied to the same components as those of FIG. 2.

The manufacturing method of the fifth exemplary embodiment has following characteristics. A transparent photosensitive resin layer 524 as a photoresist film is a positive type (photosensitized part is omitted) (FIG. 11B). When exposing the transparent photosensitive resin layer 524, light 522 is irradiated to the transparent photosensitive resin layer 524 from the bottom face 121 side through the transparent substrate 110 and a photomask 550 (FIG. 11C). The exposure amount is set to be smaller than the case of forming the section of the protruded pattern 130 as a face perpendicular to the surface 111 of the transparent substrate 110 becomes a perpendicular shape (FIG. 11C). The reason thereof is the same as that of the manufacturing method of the first exemplary embodiment.

Next, the manufacturing method according to the fifth exemplary embodiment will be described in a more detailed manner.

First, a base layer 523 is formed on the surface 111 of the transparent substrate 110 made with PET or PC, and the transparent photosensitive resin layer 524 is formed thereon (FIGS. 11A, 11B). For the base layer 523, a positive-type transparent photosensitive resin same as the transparent photosensitive resin layer 524 is used. That is, after applying the transparent photosensitive resin on the transparent substrate 110, the whole surface is cured by applying heat to form the base layer 523. The film thickness of the base layer 523 is appropriate to fall within the range of 5 μm to 30 μm, and it is set as 10 μm in the fifth exemplary embodiment. The thickness of the transparent photosensitive resin layer 524 is appropriate to fall within the range of 30 μm to 300 μm, and it is set as 60 μm in the fifth exemplary embodiment.

Subsequently, the transparent photosensitive resin layer 524 is patterned by using the mask pattern 551 of the photomask 550 (FIG. 11C). At this time, the photomask 550 is disposed on a back face 112 of the transparent substrate 110, and the light 552 is irradiated to the transparent photosensitive resin layer 524 through the photomask 550 and the transparent substrate 110. By performing the exposure and development, the protruded patterns 130 are formed on the transparent photosensitive resin layer 524 (FIG. 11D). Steps thereafter are the same as those of the manufacturing method of the first exemplary embodiment (FIGS. 3A-3C).

Other structures, operations, and effects of the fifth exemplary embodiment are the same as those described in the first exemplary embodiment.

### Sixth Exemplary Embodiment

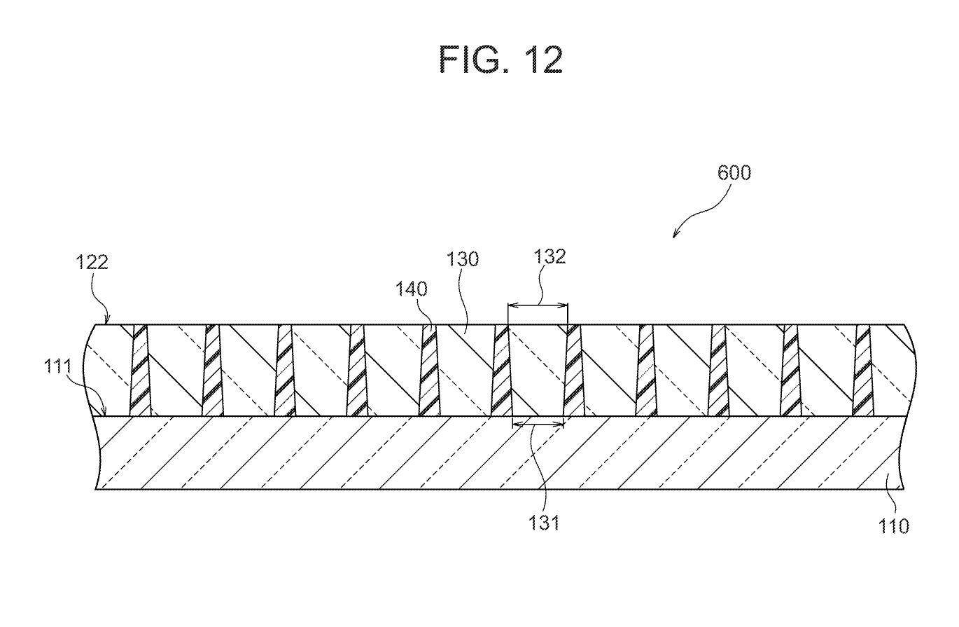

FIG. 12 is a sectional view showing a micro louver 600 according to a sixth exemplary embodiment. Hereinafter, explanations will be provided by referring to the drawing. In FIG. 12, same reference numerals as those of FIG. 1 are applied to the same components as those of FIG. 1.

The micro louver 600 of the sixth exemplary embodiment includes: the transparent substrate 110; the plurality of protruded patterns 130 formed on the surface 111 of the transparent substrate 110 by being isolated from each other; and the light absorbing layer 140 formed on the spaces between the protruded patterns 130. Further, the section of the protruded pattern 130 as the face perpendicular to the surface 111 of the transparent substrate 110 is formed in a reverse tapered shape in which the width 132 on the upper face 122 side is wider than the width 131 on the bottom face 121 side. The reason thereof is the same as the case of the first exemplary embodiment.

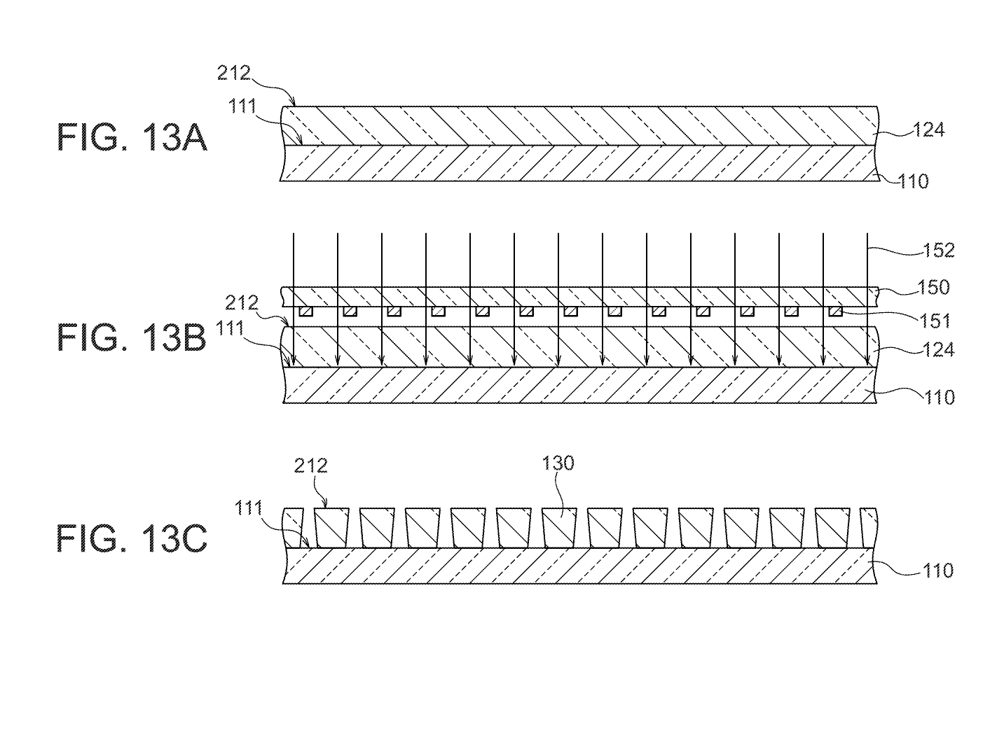

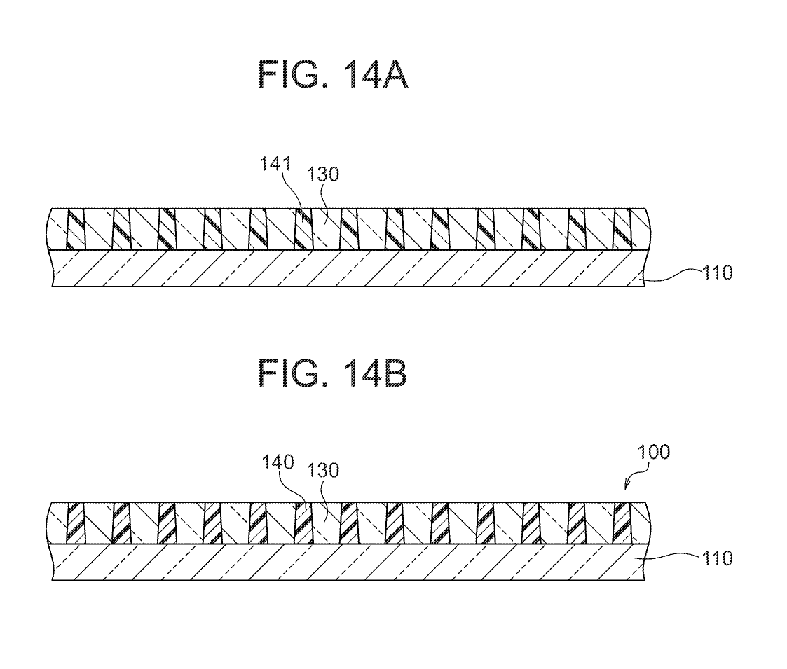

Next, the manufacturing method of the sixth exemplary embodiment will be described in a more detailed manner by referring to FIGS. 13A-13C and FIGS. 14A-14B.

First, the transparent photoresist resin layer 124 is formed on the surface 111 of the transparent substrate 110 made with PET or PC (FIG. 13A). The thickness of the transparent photosensitive resin layer 124 is appropriate to fall within the range of 30 μm to 300 μm, and it is set as 100 μm in the sixth exemplary embodiment.

Subsequently, the transparent photosensitive resin layer 124 is patterned by using the mask pattern 151 of the photomask 150 (FIG. 13B). At this time, the photomask 150 is disposed on a surface 212 of the transparent photosensitive resin layer 124, and the light 152 is irradiated to the transparent photosensitive resin layer 124 through the photomask 150.

By performing the exposure and development, the protruded patterns 130 are formed on the surface 111 of the transparent substrate 110 (FIG. 13C). Subsequently, heat annealing is performed under a condition at 120° C. for 30 minutes. Through the heat annealing, bonding at the interface between the transparent substrate 110 and the protruded pattern 130 becomes solid. Regarding steps thereafter, the black curing resin 141 is filled to the spaces between each of the protruded patterns 130 (FIG. 12D), and the black curing resin 141 is cured to form the light absorbing layer 140 (FIG. 12E) as in the case of the manufacturing method of the first exemplary embodiment.

With this, the protruded patterns 130 are formed directly on the transparent substrate 110. This makes it possible to improve the transmittance and, at the same time, to decrease the rate of generating faults by shortening the manufacturing steps.

Other structures, operations, and effects of the sixth exemplary embodiment are the same as those described in the first exemplary embodiment.

### Seventh Exemplary Embodiment

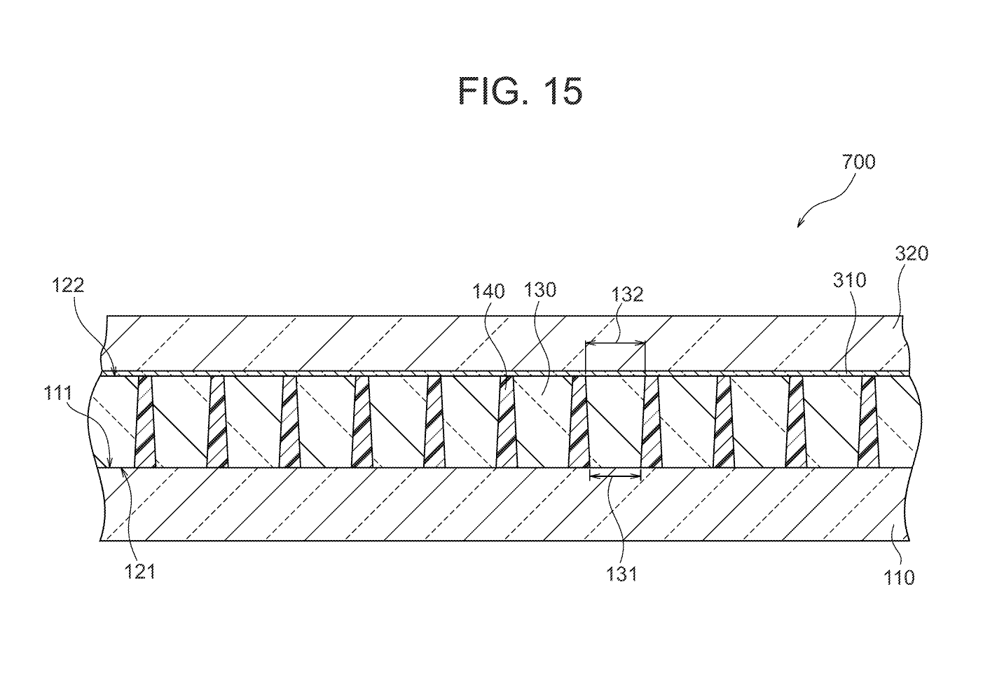

FIG. 15 is a sectional view showing a micro louver 700 according to a seventh exemplary embodiment. Hereinafter, explanations will be provided by referring to the drawing. In FIG. 15, same reference numerals are applied to the same components as those of FIG. 1, FIG. 7, FIG. 9, and FIG. 12.

In the seventh exemplary embodiment, the transparent substrate 320 is attached on the protruded patterns 130 and the light absorbing layer 140 formed on the transparent substrate 110 as in the case of the sixth exemplary embodiment via the adhesive layer 310. The film thickness of the adhesive layer 310 is appropriate to fall within the range of 5 μm to 50 μm, and it is set as 10 μm in the seventh exemplary embodiment. The refractive index of the adhesive layer 310 is set as equivalent to that of the protruded patterns 130, and the adhesive layer 310 is formed directly on the surface of the protruded patterns 130 and the light absorbing layer 140. Further, as the adhesive layer 310, it is desirable to use such type whose absorption ratio of the light in the wavelength range of 380 nm or less is roughly 90% or more.

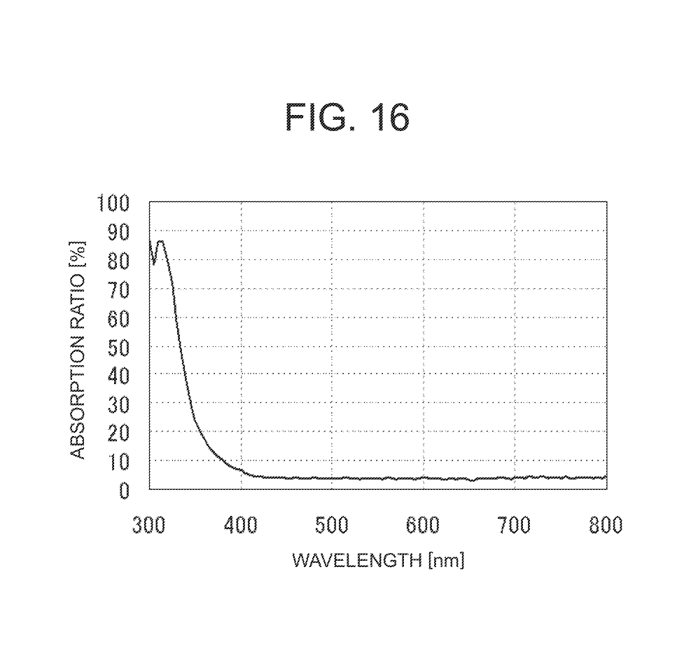

As shown in FIG. 16, the light absorption of the protruded patterns 130 becomes greater in the wavelength range of 380 nm or less. Thus, through absorbing the sunlight of this wavelength range making incident from the transparent substrate 320 side with the adhesive layer 310, deterioration of the protruded patterns 130 caused by light absorption can be suppressed. In the seventh exemplary embodiment, an acryl-based adhesive agent having the refractive index of 1.5 is used as the adhesive layer 310. With this, the strength of the surface of the protruded patterns 130 and the light absorbing layer 140 is improved, so that the rate of having faults generated due to scars and the like can be decreased. At the same time, deterioration in the transmittance caused because the light is reflected at the interface between the protruded patterns 130 and the adhesive layer 310 can be prevented.

Other structures, operations, and effects of the seventh exemplary embodiment are the same as those described in the sixth exemplary embodiment.

### Eighth Exemplary Embodiment

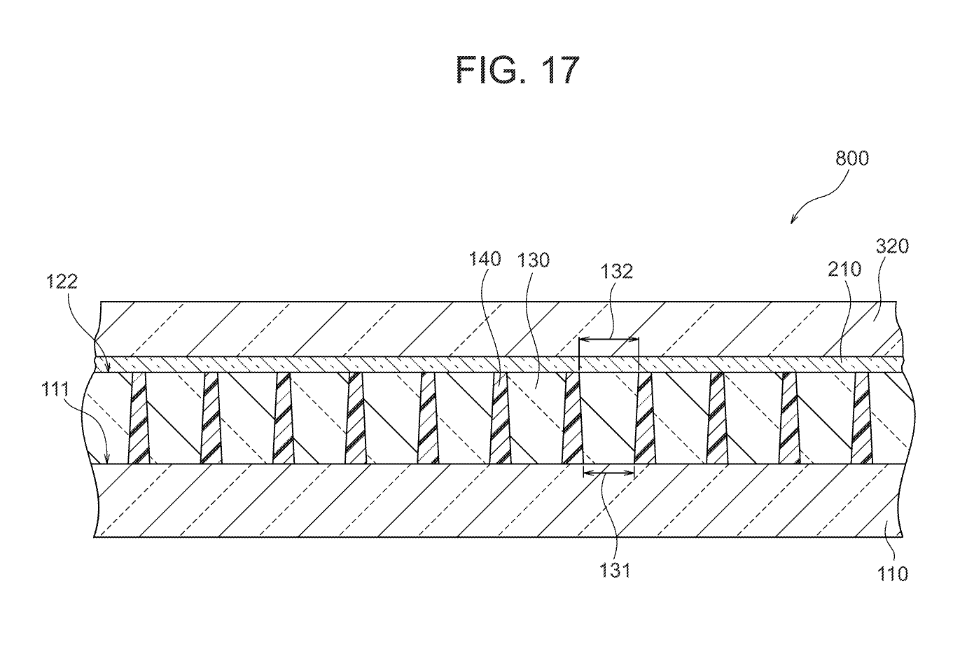

FIG. 17 is a sectional view showing a micro louver 800 according to an eighth exemplary embodiment. Hereinafter, explanations will be provided by referring to the drawing. In FIG. 17, same reference numerals are applied to the same components as those of FIG. 1, FIG. 7, FIG. 9, and FIG. 12.

In the eighth exemplary embodiment, the cover layer 210 is applied and formed in the same manner as the case of the second exemplary embodiment on the protruded patterns 130 and the light absorbing layer 140 formed on the transparent substrate 110 as in the case of the sixth exemplary embodiment. Subsequently, the transparent substrate 320 is superimposed on the formed cover layer 210. At this time, it is necessary to pay attention not to have air bubbles entered into the interface between the cover layer 210 and the transparent substrate 320. At last, the cover layer 210 is cured by heat annealing.

By heat-annealing the cover layer 210 in a state where the transparent substrate 320 is being superimposed, the transparent substrate 320 is fixed with the cover layer 210. Thus, an adhesive layer becomes unnecessary, so that the cost can be reduced. Further, the refractive index of the cover layer 210 is desirable to be set as equivalent to the refractive index of the light absorbing layer 140 or larger.

Other structures, operations, and effects of the eighth exemplary embodiment are the same as those described in the sixth exemplary embodiment.

### (Summary)

The present invention can also be described as follows.

An exemplary object of the present invention is to provide a micro louver that is capable of preventing generation of faults such as excessive wiping of the light absorbing layer through narrowing the space width between each of the protruded patterns of the transparent layer without having the protruded patterns overlapped on one another and without generating faults such as aggregation of the protruded patterns during the process of forming the protruded patterns. This makes it possible to reduce the cost of the micro louver by reducing variations in the characteristics and improving the yield.

The optical element of the present invention restricts the range of the exit direction of the light transmitting through the protruded patterns of the transparent layer by the light absorbing layer formed on the spaces between the protruded patterns, and it is so characterized that the shape of the protruded pattern is formed in a reverse tapered shape that becomes wider towards the surface side from the substrate side.

With the above-described shape, it is possible to prevent faults in forming the light absorbing layer caused due to excessive wiping of the black ink through narrowing the space width between each of the protruded patterns of the transparent layer without having the protruded patterns overlapped on one another and without generating faults such as aggregation of the protruded patterns during the process of forming the transparent layer.

With the present invention, it is possible to prevent generation of faults in the protruded patterns of the transparent layer and to prevent generation of faults in the characteristics caused due to faults in the patterns of the light absorbing layer. This makes it possible to improve functions and the yields and also to reduce the cost.

While the present invention has been described above by referring to the specific exemplary embodiments shown in the accompanying drawings, the present invention is not limited only to each of the exemplary embodiments shown in the drawings. Any changes and modifications occurred to those skilled in the art can be applied to the structures and the details of the present invention. Further, it is to be noted that the present invention includes combinations of a part of or the entire part of the structures of each of the exemplary embodiments combined mutually in an appropriate manner.

While a part of or the entire part of the exemplary embodiments can be summarized as in following Supplementary Notes, the present invention is not necessarily limited to those structures.

### (Supplementary Note 1)

An optical element which includes:
a transparent substrate;
a transparent layer formed on a surface of the transparent substrate;
provided that a face of the transparent layer in contact with the transparent substrate is referred to as a bottom face and an opposite side of the bottom face is referred to as an upper face, a plurality of protruded patterns formed in the transparent layer by being isolated from each other by having an upper face as a top face; and
a light absorbing layer formed on spaces between each of the protruded patterns, wherein
regarding a section of the protruded pattern as a face perpendicular to the surface of the transparent substrate, a width on the upper face side is wider than a width on the bottom face side.

### (Supplementary Note 2)

The optical element as depicted in Supplementary Note 1, which further includes another transparent substrate provided on the transparent layer and the light absorbing layer.

### (Supplementary Note 3)

The optical element as depicted in Supplementary Note 1, which further includes a transparent cover layer provided on the transparent layer and the light absorbing layer, wherein the cover layer is formed by being closely adhered to the light absorbing layer.

### (Supplementary Note 4)

The optical element as depicted in Supplementary Note 3, which further includes another transparent substrate provided on the cover layer.

### (Supplementary Note 5)

The optical element as depicted in Supplementary Note 3 or 4, wherein a refractive index of the cover layer is equivalent to or larger than a refractive index of the light absorbing layer.

### (Supplementary Note 6)

The optical element as depicted in any one of Supplementary Notes 3 to 5, wherein:
the cover layer is formed with a resin; and
the light absorbing layer is a mixture of the resin constituting the cover layer and a light shielding component.

### (Supplementary Note 7)

The optical element as depicted in Supplementary Note 6, wherein the light shielding component is a dye or a pigment.

### (Supplementary Note 8)

The optical element as depicted in any one of Supplementary Notes 3 to 7, wherein the cover layer is formed with a bisphenol A epoxy resin which is cured by applying heat.

### (Supplementary Note 9)

The optical element as depicted in any one of Supplementary Notes 1 to 8, wherein the transparent layer is formed by exposing and developing a transparent photosensitive resin, which is then cured by applying heat.

### (Supplementary Note 10)

An optical element which includes:
a transparent substrate;
a plurality of protruded patterns formed on a surface of the transparent substrate by being isolated from each other and, provided that a face in contact with the transparent substrate is referred to as a bottom face and an opposite side of the bottom face is referred to as an upper face, by having the upper face as a top face; and
a light absorbing layer formed on spaces between each of the protruded patterns, wherein
regarding a section of the protruded pattern as a face perpendicular to the surface of the transparent substrate, a width on the upper face side is wider than a width on the bottom face side.

### (Supplementary Note 11)

The optical element as depicted in Supplementary Note 10, which further includes:
a transparent adhesive layer provided on the protruded patterns and the light absorbing layer; and
another transparent substrate provided on the adhesive layer, wherein
the adhesive layer is formed by being closely adhered to the protruded patterns, the light absorbing layer, and the another transparent substrate.

### (Supplementary Note 12)

The optical element as depicted in Supplementary Note 11, wherein a light absorption ratio of the adhesive layer in a wavelength range of 380 nm or less is roughly 90% or higher.

### (Supplementary Note 13)

The optical element as depicted in Supplementary Note 10, which further includes:
a transparent cover layer provided on the protruded patterns and the light absorbing layer; and
another transparent substrate provided on the cover layer, wherein
the cover layer is formed by being closely adhered to the protruded patterns, the light absorbing layer, and the another transparent substrate.

### (Supplementary Note 14)

An optical element manufacturing method, which includes:
forming a photoresist film to be a transparent layer on a surface of a transparent substrate;
provided that a face of the photoresist film in contact with the transparent substrate is a bottom face and an opposite side of the bottom face is an upper face, exposing the photoresist film by irradiating light to the photoresist film through a photomask;
forming a plurality of protruded patterns isolated from each other by having the upper face as a top face through immersing the exposed photoresist film into a developing solution; and
applying a liquid resin to be a light absorbing layer to the upper face including the spaces between each of the protruded patterns, and wiping off the excessive liquid resin from the upper face, wherein
when exposing the photoresist film, the exposure amount is adjusted so that the width on the upper face side of the section of the protruded pattern, which is a face perpendicular to the surface of the transparent substrate, becomes wider than the width on the bottom face side.

### (Supplementary Note 15)

The optical element manufacturing method as depicted in Supplementary Note 14, wherein:
the photoresist film is a negative type;
when exposing the photoresist film, light is irradiated to the photoresist film from the upper face side through the photomask; and
the exposure amount is reduced than a case where the width on the bottom face side and the width on the upper face side in the section of the protruded pattern as a face perpendicular to the surface of the transparent substrate are equivalent.

### (Supplementary Note 16)

The optical element manufacturing method as depicted in Supplementary Note 14, wherein:
the photoresist film is a positive type;
when exposing the photoresist film, light is irradiated to the photoresist film from the bottom face side through the transparent substrate and the photomask; and
the exposure amount is reduced than a case where the width on the bottom face side and the width on the upper face side in the section of the protruded pattern as a face perpendicular to the surface of the transparent substrate are equivalent.

### (Supplementary Note 21)

An optical element, wherein:
a transparent layer, which includes on its surface a plurality of protruded patterns isolated from each other, is formed on the surface of a transparent substrate;
a light absorbing layer is formed in spaces between each of the protruded patterns of the transparent layer; and
the side-face shape of the protruded pattern is formed to be wider on the surface side of the transparent layer than the transparent substrate side.

### (Supplementary Note 22)

An optical element, wherein:
a transparent layer, which includes on its surface a plurality of protruded patterns isolated from each other, is formed on the surface of a transparent substrate;
a light absorbing layer is formed in spaces between each of the protruded patterns of the transparent layer;
the surface of the protruded pattern is in a flat shape; and
the side-face of the protruded pattern is formed to be wider on the surface side of the transparent layer than the transparent substrate side.

### (Supplementary Note 23)

The optical element as depicted in Supplementary Note 21 or 22, wherein another transparent substrate is disposed on the surface of the transparent layer and the light absorbing layer.

### (Supplementary Note 24)

The optical element as depicted in Supplementary Note 21 or 22, wherein:
a cover layer is formed on the surface of the transparent layer and the light absorbing layer; and
the cover layer is formed by being closely adhered to the surface of the light absorbing layer.

### (Supplementary Note 25)

The optical element as depicted in Supplementary Note 24, wherein another transparent substrate is disposed on the surface of the cover layer.

### (Supplementary Note 26)

The optical element as depicted in Supplementary Note 24 or 25, wherein the cover layer is formed with a transparent resin whose refractive index is equivalent to or larger than the refractive index of the light absorbing layer.

### (Supplementary Note 27)

The optical element as depicted in any one of Supplementary Notes 21 to 26, wherein the light absorbing layer is a mixture of the resin constituting the cover layer and a light shielding component.

### (Supplementary Note 28)

The optical element as depicted in any one of Supplementary Notes 21 to 27, wherein the light shielding component of the light absorbing layer is constituted with a pigment such as a dye or black carbon.

### (Supplementary Note 29)

The optical element as depicted in any one of Supplementary Notes 21 to 28, wherein the cover layer is formed with a bisphenol A epoxy resin which is cured by applying heat.

### (Supplementary Note 30)

The optical element as depicted in any one of Supplementary Notes 21 to 29, wherein the transparent layer is formed by exposing and developing a transparent resist, which is cured by exposure and applying heat.

### INDUSTRIAL APPLICABILITY

The present invention can be utilized to any optical elements that restrict the range of exit directions of transmission light. An example of such optical elements is a micro louver used in a liquid crystal display device, an EL display, a plasma display, a lighting optical device, and the like.

What is claimed is:

1. An optical element, comprising:
a transparent substrate;
a transparent layer formed on a surface of the transparent substrate;
provided that a face of the transparent layer in contact with the transparent substrate is referred to as a bottom face and an opposite side of the bottom face is referred to as an upper face, a plurality of protruded patterns formed in the transparent layer by being isolated from each other by having an upper face as a top face; and
a light absorbing layer formed on spaces between each of the protruded patterns, wherein
regarding a section of the protruded pattern as a face perpendicular to the surface of the transparent substrate, a width on the upper face side is wider than a width on the bottom face side.

2. The optical element as claimed in claim 1, further comprising another transparent substrate provided on the transparent layer and the light absorbing layer.

3. The optical element as claimed in claim 1, further comprising a transparent cover layer provided on the transparent layer and the light absorbing layer, wherein
the cover layer is formed by being closely adhered to the light absorbing layer.

4. The optical element as claimed in claim 3, further comprising another transparent substrate provided on the cover layer.

5. The optical element as claimed in claim 3, wherein
a refractive index of the cover layer is equivalent to or larger than a refractive index of the light absorbing layer.

6. The optical element as claimed in claim 3, wherein:
the cover layer is formed with a resin; and
the light absorbing layer is a mixture of the resin constituting the cover layer and a light shielding component.

7. The optical element as claimed in claim 6, wherein
the light shielding component is a dye, a pigment, or a mixture of a dye and a pigment.

8. The optical element as claimed in claim 3, wherein
the cover layer is formed with a bisphenol A epoxy resin which is cured by applying heat.

9. The optical element as claimed in claim 1, wherein
the transparent layer is formed by exposing and developing a transparent photosensitive resin, which is then cured by applying heat.

10. An optical element, comprising:
a transparent substrate;
a plurality of protruded patterns formed on a surface of the transparent substrate by being isolated from each other and, provided that a face in contact with the transparent substrate is referred to as a bottom face and an opposite side of the bottom face is referred to as an upper face, by having the upper face as a top face; and
a light absorbing layer formed on spaces between each of the protruded patterns, wherein
regarding a section of the protruded pattern as a face perpendicular to the surface of the transparent substrate, a width on the upper face side is wider than a width on the bottom face side.

11. The optical element as claimed in claim 10, further comprising:
a transparent adhesive layer provided on the protruded patterns and the light absorbing layer; and
another transparent substrate provided on the adhesive layer, wherein
the adhesive layer is formed by being closely adhered to the protruded patterns, the light absorbing layer, and the another transparent substrate.

12. The optical element as claimed in claim 11, wherein
a light absorption ratio of the adhesive layer in a wavelength range of 380 nm or less is roughly 90% or higher.

13. The optical element as claimed in claim 10, further comprising:
a transparent cover layer provided on the protruded patterns and the light absorbing layer; and
another transparent substrate provided on the cover layer, wherein
the cover layer is formed by being closely adhered to the protruded patterns, the light absorbing layer, and the another transparent substrate.
